(19) United States
(12) Patent Application Publication
(10) Pub. No.: US 2007/0005831 A1
(43) Pub. Date: Jan. 4, 2007

(54) Semiconductor memory system

(76) Inventor: Peter Gregorius, Muenchen (DE)

Correspondence Address: DICKE, BILLIG & CZAJA, P.L.L.C., FIFTH STREET TOWERS, 100 SOUTH FIFTH STREET, SUITE 2250, MINNEAPOLIS, MN, 55402, US

(21) Appl. No.: 11/171,110

(22) Filed: Jun. 30, 2005

(51) Int. Cl. G06F 5/00; G06F 3/00

(52) U.S. Cl. 710/52

(57) ABSTRACT

The present invention relates to a semiconductor memory system including a memory controller transmitting high speed write data, command and address signal streams based on a predefined transmission protocol and a high speed write clock signal and for receiving serial high speed read data signals as signal frames based on the transmission protocol and a memory module which includes a plurality of semiconductor memory chips and a smart buffer chip which is different from prior art register chips because it forms a genuine high speed serial link including the complete digital function thereof such as protocol layer, error coding and so on. The smart buffer chip communicates with the memory chips by a low speed interface and through low speed point-to-point or fly-by connection lines.

### BACKGROUND

The present invention relates to a semiconductor memory system in which a memory module carrying a plurality of semiconductor memory chips is connected to a memory controller by means of write data, command and address signal bus lines, read data bus lines and a clock signal line.

A variety of concepts are discussed to increase the storage density of future semiconductor memory systems and/or semiconductor memory modules. Arrangement of semiconductor memory chips in form of a daisy-chain or in a star configuration are favourable examples of such new concepts. Additionally the number of connection lines, that is the bus width of the communication lines between the memory controller and the memory chips should be reduced. To transfer signals having the same or higher band widths (GB/s) via a signal bus with a reduced bus width it is necessary to convert a parallel data stream originating from the memory chips to a higher symbol rate. For this reason the data are serialized. Also write data, command and address signals are serially transmitted from the memory controller.

Enclosed FIG. 1 schematically depicts a functional block diagram of a memory system having a memory module MM on which for example four memory chips M1-M4 are serially arranged in form of a daisy-chain and connected to a memory controller MC. MC includes a high speed serial output interface MCOUT for transmitting serial high speed write data/command and address signals HSWR/CAe as well as a clock signal CLK to the memory module MM and further includes a high speed serial input interface MCIN for receiving high speed serial read data HSRD from the memory module MM. Each memory chip M1-M4 in the daisy-chain includes a high speed link “High-speed in” and “High-speed out” and a re-drive/repeater function. The received serial data stream is converted to the memories internal symbol rate. For sending read data from one or more of the memory chips M1-M4 to the MC each memory chip M1-M4 converts its data to the symbol rate of the high speed link. The internal interface to the memory array A (memory core) is constructed as a parallel low speed link (“Array interface in” and “Array interface out”) having a corresponding bus width.

In the example described above and illlustrated in FIG. 1 four different ranks R1 to R4 are respectively associated to four memory chips M1 to M4.

One essential drawback of the memory system depicted in FIG. 1 is that each memory chip M1-M4 requires a high speed link having a repeater/re-drive function, and thus the memory chips have a complicated I/O interface construction which inevitably has high power consumption. The memory controller MC in the daisy-chain arrangement depicted in FIG. 1 or in a star topology physically communicates only with one high speed interface, that is the high speed interface of the first memory chip M1. The further memory chips M2, M3 and M4 of the daisy-chain are visible only indirectly by the memory controller (re-drive function of the memory chips). The memory controller is connected to the first memory chip M1 by means of a unidirectional point-to-point connection. Bus width may be for example 6 HSWR/CAe lines and 8 lines of HSRD bus. Also the connection between the memory chips is unidirectional point-to-point. The memory chips in the chain can be activated only sequentially, that is the high speed protocol is transmitted sequentially.

### SUMMARY

One embodiment of the invention provides a semiconductor memory system including a memory controller arranged for transmitting serial high speed write data, command and address signal streams as signal frames based on a predefined transmission protocol through a point-to-point write data, and a command and address signal bus having a predetermined write bus width and a high speed write clock signal and for receiving serial high speed read data signal streams as signal frames on the basis of said transmission protocol through a point-to-point-read data bus having a predetermined read bus width. A memory module is connected to said memory controller by means of said point-to-point-read data bus, said point-to-point write data, command and address signal bus and a write clock signal line.

The memory module includes a smart buffer chip and a plurality of semiconductor memory chips having low speed input/output interface sections, connected to low speed write data lines, low speed command and address signal lines, low speed memory clock signal lines and low speed read data signal lines. The semiconductor memory chips and said low speed signal lines are arranged on said memory module according to a certain topology for receiving low speed write data signals, command and address signals and a low speed memory clock signal from said smart buffer chip and for transmitting low speed read data signals to said smart buffer chip. The smart buffer chip is interposed as a high speed serial link between said memory chips and said memory controller.

The smart buffer includes a high speed interface section being connected to said memory controller by means of said point-to-point read data bus, said point-to-point write data, command and address signal bus and said write clock signal line for receiving from said memory controller said serial high speed write data, command and address signal streams and said write clock signal and transmitting said serial high speed read data signal streams to said memory controller. A low speed interface section is connected to said memory chips through said low speed write data lines, said low speed command and address signal lines, memory clock signal lines and low speed read data signal lines for transmitting to said memory chips said low speed write data, said command and address signals and said memory clock signal and for receiving said low speed read data signals from said memory modules. A digital control unit is interposed between the high speed and the low speed interface sections and carrying out at least functions of buffering, speed converting and rearranging the signals flowing between the high speed and low speed interface sections, signal framing and frame decoding according to the protocol, code redundancy coding, decoding and error checking and command and address signal decoding.

The smart buffer also including a high speed clock generator and a low speed clock generator. The high speed clock generator is adapted for generating high speed transmission and reception clock signals derived from the high speed write clock signal, and said low speed clock generator being adapted for generating low speed transmission and reception clock signals and said low speed memory clock signal each on the basis of a low speed base clock signal obtained by frequency dividing said high speed write clock signal from said memory controller.

The low speed components of one embodiment of the present memory system operate and transmit data at a low frequency which is essentially lower than the operational and transmission frequency of the high speed components.

### BRIEF DESCRIPTION OF THE DRAWINGS

The accompanying drawings are included to provide a further understanding of the present invention and are incorporated in and constitute a part of this specification. The drawings illustrate the embodiments of the present invention and together with the description serve to explain the principles of the invention. Other embodiments of the present invention and many of the intended advantages of the present invention will be readily appreciated as they become better understood by reference to the following detailed description. The elements of the drawings are not necessarily to scale relative to each other. Like reference numerals designate corresponding similar parts.

FIG. 1 schematically illustrates an exemplifying functional block diagram of a semiconductor memory system having a high transmission speed throughout the whole system and a high speed serial link between a memory module and a memory controller.

FIG. 2 schematically illustrates a functional block diagram of a semiconductor memory system according to one embodiment of the present invention in which a smart buffer chip is arranged on the memory module having low speed point-to-point output and input interface sections to the memory chips.

FIG. 3 schematically illustrates a functional block diagram of one embodiment of the present semiconductor memory system in which a smart buffer chip arranged on the memory module has low speed fly-by input and output interface sections for connecting the memory chips in a fly-by fashion.

FIG. 4 schematically illustrates a functional block diagram of one embodiment of the present semiconductor memory system in which the low speed transmission between the low speed output and low speed input interface and the memory chips is performed through a point-to-point bus and a fly-by bus connection, respectively.

FIG. 5 schematically illustrates a functional block diagram of one embodiment of the present semiconductor memory system in which the low speed output and input interface sections of the smart buffer chip are connected to the memory chips by means of a fly-by bus and a point-to-point bus, respectively.

FIG. 6 schematically illustrates a functional block diagram of one preferred embodiment of the smart buffer chip to be used in various embodiments of the present semiconductor memory system depicted in FIGS. 2 to 5.

### DETAILED DESCRIPTION

In the following Detailed Description, reference is made to the accompanying drawings, which form a part hereof, and in which is shown by way of illustration specific embodiments in which the invention may be practiced. In this regard, directional terminology, such as “top,” “bottom,” “front,” “back,” “leading,” “trailing,” etc., is used with reference to the orientation of the Figure(s) being described. Because components of embodiments of the present invention can be positioned in a number of different orientations, the directional terminology is used for purposes of illustration and is in no way limiting. It is to be understood that other embodiments may be utilized and structural or logical changes may be made without departing from the scope of the present invention. The following detailed description, therefore, is not to be taken in a limiting sense, and the scope of the present invention is defined by the appended claims.

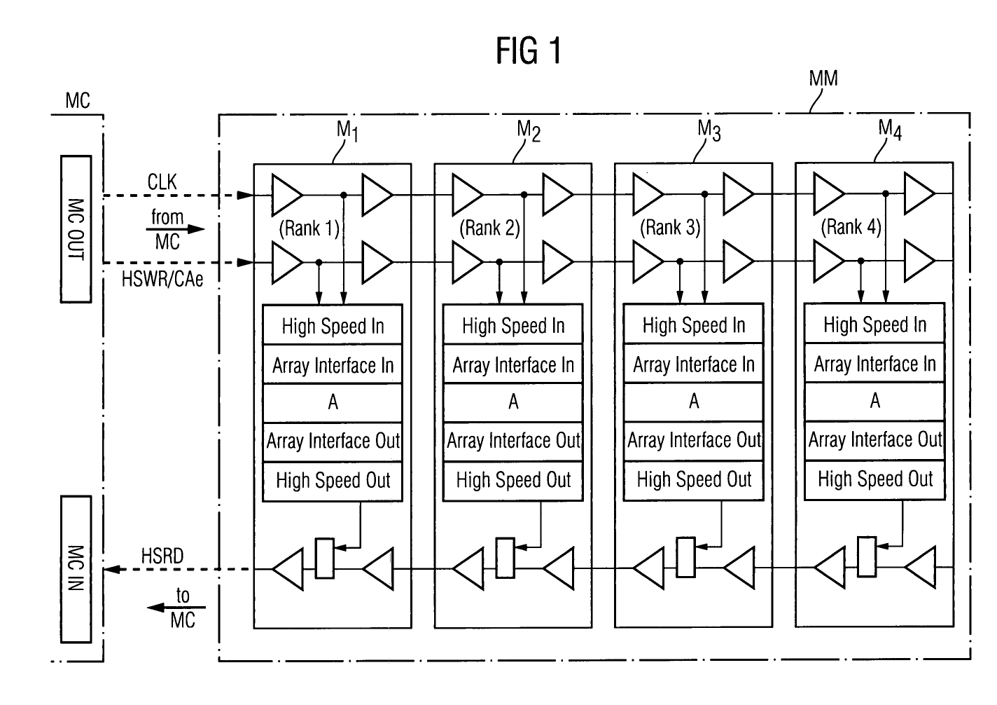

One embodiment of a semiconductor memory system separates the high speed links from the memory chips and replaces the high speed links by one high speed interface section integrated in the smart buffer chip. Thus, the smart buffer chip is used for the high speed communication with the memory controller. This embodiment of the smart buffer chip is different from prior art register chips because it is constructed as a high speed serial link and includes the complete digital functions thereof as for example a protocol layer, error coding, frame coding and decoding, and so on. The smart buffer chip communicates with the memory chips through a proprietary low speed interface. Concerning data communication the present semiconductor memory system exhibits the same function for the memory controller as the semiconductor memory system described above and depicted in FIG. 1.

According to one embodiment of the present semiconductor memory system said memory chips are arranged on said memory module and connected with the smart buffer chip by said low speed write data lines, low speed command and address signal lines and by said low speed read data lines in a point-to-point fashion. The low speed interface section of the smart buffer chip includes a first number of low speed write signal transmitting units, a second number of low speed command and address signal transmitting units and a third number of low speed read signal receiving units, wherein said first, second and third number are respectively corresponding to the product of a number of the of memory chips on the memory module and a bit width of the low speed write data lines, command and address signal lines and low speed read data lines.

According to one embodiment of the present semiconductor memory system said memory chips are arranged on said memory module and connected with the smart buffer chip by said low speed write data lines, said low speed command and address signal lines and said low speed read data lines, in a fly-by-bus fashion. The low speed interface section of the smart buffer chip includes a first number of low speed write signal transmitting units, a second number of low speed command and address signal transmitting units, and a third number of low speed read signal receiving units, wherein said first, second and third number are respectively corresponding to the respective bit width of the low speed write data lines, low speed command and address signal lines and low speed read data lines.

According to one embodiment of the present semiconductor memory system said memory chips are arranged on said memory module and connected with the smart buffer chip by said low speed write data lines and said low speed command and address signal lines in a point-to-point-fashion and by said low speed read data lines in a fly-by-bus fashion. The low speed interface section of the smart buffer chip includes a first number of low speed write signal transmitting units and a second number of low speed command and address signal transmitting units, wherein said first and second number are respectively corresponding to the product of a number of the memory chips on the memory module and a bit width of the low speed write data lines and a bit width of the command and address signal lines, respectively, and a third number of low speed read signal receiving units which is corresponding to a bit width of said low speed read data lines.

According to one embodiment of the present semiconductor memory system, said memory chips are arranged on said memory module and connected with said smart buffer chip by said low speed write data lines and said low speed command and address signal lines from said smart buffer chip in a fly-by-bus fashion and by said low speed read data lines to said smart buffer chip in a point-to-point-fashion. The low speed interface section of the smart buffer chips includes a first number of low speed write signal transmitting units, a second number of low speed command and address signal transmitting units, wherein said first and second number are respectively corresponding to a bit width of said low speed write data lines and a bit width of the low speed command and address signal lines, respectively, and a third number of identical low speed read signal receiving units which is corresponding to the product of a number of the plurality of memory chips on the memory module and a bit width of said low speed read data lines.

According to one embodiment of the present semiconductor memory system said high speed interface section includes a first number of transmission signal serializing and synchronizing output buffer circuits clocked and synchronized by said high speed transmitter clock signal from said high speed clock generator. Each output buffer circuit has means for buffering parallel read data signals received in form of signal frames from said digital control unit, parallel-to-serial converting said parallel read data signals into a high speed serial read data stream, synchronizing and de-emphasizing said high speed serial read data streams by said high speed transmission clock signal, and driving said synchronized and de-emphasized serial high speed read data stream to said memory controller, wherein said first number corresponds to the read bus width.

The high speed interface section also includes a second number of reception signal parallelizing and synchronizing input buffer circuits, clocked and synchronized by said high speed receiver clock signal from said high speed clock generator. Each input buffer circuit has means for receiving said serial high speed write data, command and address signal frames from said memory controller, synchronizing said serial high speed write data, command and address signal streams by said high speed reception clock signal, serial-to-parallel converting said serial high speed high data, command and address signal streams to parallel high speed write data, command and address signals, and buffering said parallel high speed write data, command and address signals for handing it over to said digital control unit, wherein said second number corresponds to the write bus width.

According to one embodiment of the present semiconductor memory system, said low speed interface section includes a plurality of low speed write signal transmitting units, a plurality of low speed command and address signal transmitting units, and a plurality of low speed read signal receiving units. Each of said low speed write signal transmitting units and said command and address signal transmitting units includes means for buffering frame decoded parallel low speed write data signals from said digital control unit, synchronizing the buffered parallel low speed write data signals with the low speed transmission clock signal, and driving said synchronized low speed write data signals to one or more of said memory chips through said low speed write data lines. Each of said low speed read signal receiving units includes means for receiving said low speed read data signals in parallel from one or more of said memory chips through said low speed read data signal lines, synchronizing said received low speed read data signals with said low speed reception clock signal, and buffering said synchronized low speed read data signals for handing over them to said digital control unit.

According to one embodiment of the present semiconductor memory system, said high speed clock generator includes a phase-locked loop based or a delay-locked loop based high speed clock generation circuit arranged for receiving said high speed write clock signal from said memory controller and generating in a phase-locked relation or in a delay-locked relation thereto said high speed transmission clock signal and said high speed reception clock signal, respectively, and a clock divider/buffer circuit adapted for dividing the clock frequency of the high speed write clock signal by a predetermined number and buffering the divided clock signal as the base clock signal to supply it to the digital control unit.

According to one embodiment of the present semiconductor memory system, said low speed clock generator includes a phase-locked loop based or a delay locked-loop based low speed clock generation circuit arranged for receiving said low speed base clock signal from the clock divider/buffer circuit in said high speed clock generator and generating in a phase-locked relation or a delay locked relation thereto said low speed transmission clock signal, said low speed reception clock signal and said low speed memory clock signal.

According to one embodiment of the present semiconductor memory system, said digital control unit includes a read signal processing section including in the sequence of read signal flow: a memory read control unit connected to an output side of the buffering means of each of said low speed read signal receiving units; a de-skew unit; a posted read buffer; a CRC coding and reordering unit; and a framing unit, the output of which is connected to the buffering means of the high speed interface section. The processing of said units of said read signal processing section are controlled by a read finite state machine of said digital control unit, and a write, command and address signal processing section including in the sequence of write, command and address signal flow: a de-skew and CRC coding unit connected to an output side of said buffering means of said reception signal parallelizing and synchronizing input buffer circuits; a frame decoding unit; a command and address decoding unit; a posted write buffer unit; and a memory write control unit. The memory write control unit arranged for receiving: decoded command and address signals from the command and address decoding unit; frame decoded write data signals from the frame decoding unit; CRC bits from the de-skew and CRC coding unit; and buffered posted write signals from the posted write buffer unit and handing over the processed low speed write data signals and the processed low speed command and address signals to the buffering means of said low speed write signal transmitting units and said low speed command and address signal transmitting units, respectively. The processing of said units of said write, command and address signal processing section is controlled by a write finite state machine of said digital control unit.

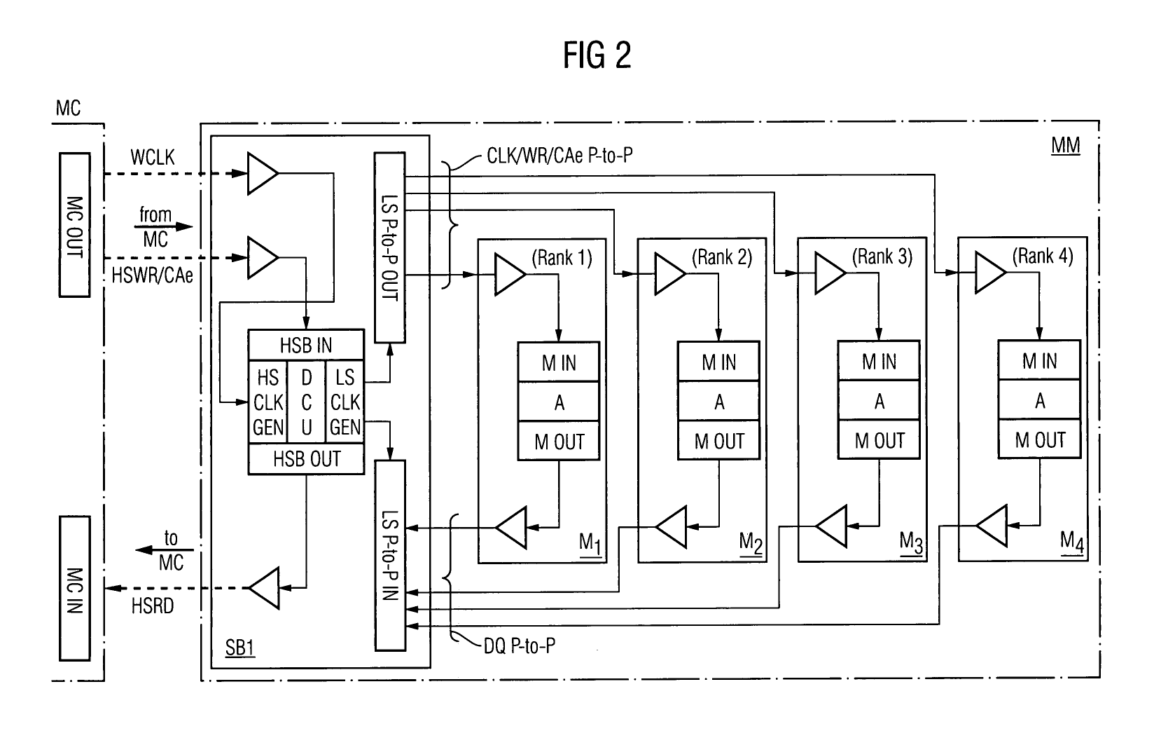

The following description will describe with reference to FIGS. 2 to 5 embodiments of the present semiconductor memory system, wherein equal designations and reference signs denote equal functional blocks.

Now referring to FIG. 2, the following description describes one embodiment of a semiconductor memory system which includes:
a) a memory controller MC including a high speed serial output interface MCOUT and a high speed serial input interface MCIN, respectively, arranged for transmitting serial high speed write data, command and address signal streams HSWR/CAe as signal frames based on a predefined transmission protocol and a high speed write clock signal WCLK each through a point-to-point write data, command and address signal bus, having a predetermined write bus width and a write clock like and further for receiving serial high speed read data signal streams HSRD as signal frames on the basis of said transmission protocol through a point-to-point read data bus having a predetermined read bus width and
b) a memory module MM connected to said memory controller MC through said high speed point-to-point read data bus, said high speed point-to-point write data, command and address signal bus and said write clock signal line.

The memory module MM includes a plurality of semiconductor memory chips M1-M4 connected to a smart buffer chip SB1 by means of first low speed point-to-point bus connection lines for transmitting low speed point-to-point clock, write data and command and address signals CLK/WR/CAe-P-to-P from a low speed point-to-point output interface section LS P-to-P OUT of the smart buffer chip SB1 to the semiconductor memory chips M1-M4. Further the memory chips M1-M4 are connected by point-to-point bus signal lines to a low speed point-to-point input interface LS P-to-P IN of said smart buffer chip SB1 for transmitting low speed point-to-point data query signals (read signals) DQ P-to-P from said memory chips M1-M4 to said smart buffer chip SB1.

Each memory chip M1-M4 comprises a low speed memory input interface MIN, a memory cell array (or memory core) A and a low speed memory output interface MOUT, wherein each low speed memory input interface MIN, memory cell array A and low speed memory output interface MOUT of said memory chips M1-M4 respectively have principally the same circuit construction. Each low speed memory input interface MIN is connected in point-to-point fashion through one signal lane of the point-to-point bus to the low speed point-to-point output interface section LS P-to-P OUT of the smart buffer chip SB1 for receiving from there parallel low speed clock/write data/command and address signals CLK/WR/CAe in a point-to-point fashion.

Each low speed memory output interface MOUT is connected by one point-to-point signal transmission lane to said low speed point-to-point input interface section LS P-to-P IN of said smart buffer chip SB1 for transmitting parallel low speed data query (read) signals DQ P-to-P in a point-to-point fashion to said smart buffer chip SB1.

Further, said smart buffer chip SB1, as depicted in FIG. 2 includes a high speed buffer input interface HSBIN and a high speed buffer output interface HSBOUT together forming a high speed buffer interface to the memory controller's high speed serial output interface MCOUT and high speed serial interface MCIN, respectively.

The smart buffer chip SB1 further includes a high speed clock generator HSCLKGEN receiving said write clock signal WCLK from MC and generating a high speed transmission clock signal TXCLK(HS) for synchronizing and clocking the high speed buffer output interface HSBOUT and a high speed reception clock signal RXCLK(HS) for synchronizing and clocking said high speed buffer input interface HSBIN of said smart buffer chip SB1. The high speed clock generator HSCLKGEN further includes a clock divider/buffer unit (not illustrated in FIG. 2) for generating a low frequency base clock signal BCLK used for synchronizing/clocking a digital control unit DCU as well as clocking a low speed clock generator LSCLKGEN of the smart buffer chip SB1.

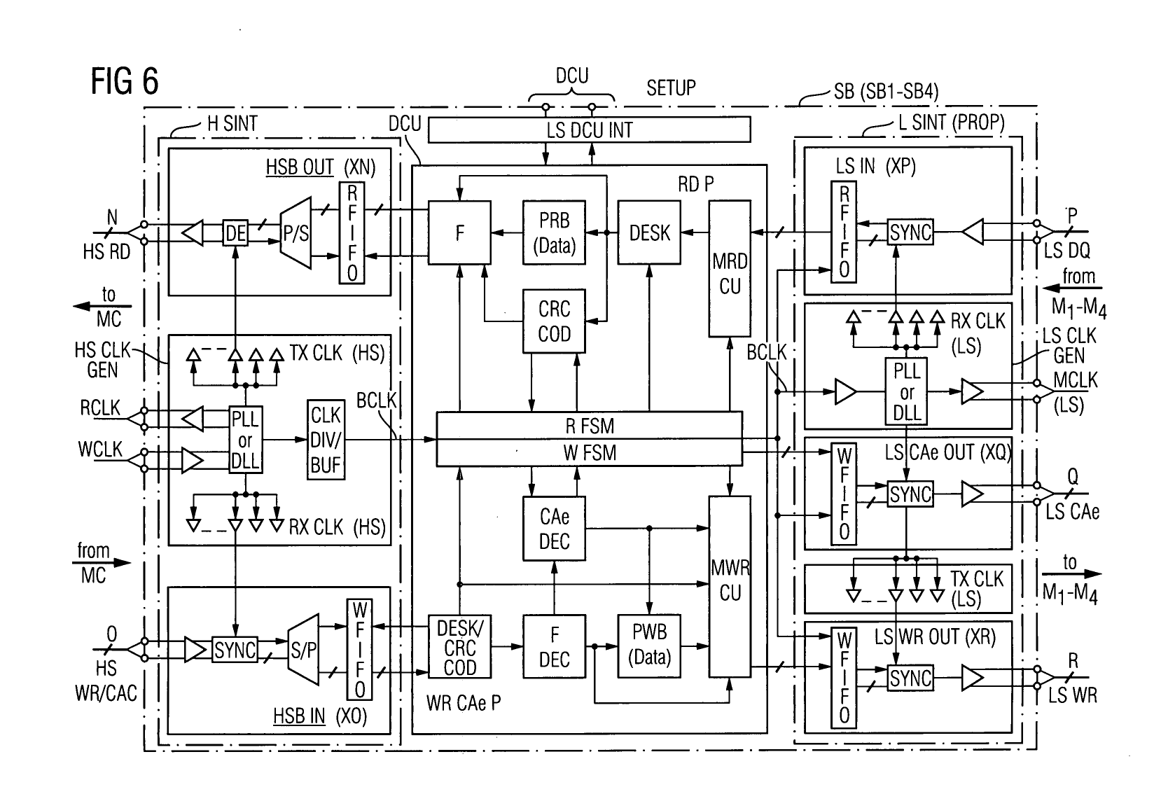

The smart buffer chips SB1, SB2, SB3 and SB4 of the embodiments according to FIGS. 2 to 5 differ in their hardware construction of the low speed output interface, and that the hardware construction of the other components of the smart buffer chips SB1 to SB4 is principally identical. The functions and principle constructions of the components of the smart buffer chips SB1 to SB4 according to the embodiments illustrated in FIGS. 2 to 5 are explained later with reference to FIG. 6.

Referring again to FIG. 2, the semiconductor memory system according to one embodiment has the topology, wherein said memory chips M1-M4 are arranged on said memory module MM and connected by said low speed write data lines, low speed command and address signal lines and by said low speed read data lines from/to said smart buffer chips SB1 for respectively transmitting low speed memory clock write data, command and address signals CLK/WR/CAE P-to-P in a point-to-point fashion from the smart buffer chip SB1 to said memory chips M1 to M4 and for receiving the low speed read data signals DQP-to-P also in a point-to-point fashion from said memory chips M1 to M4.

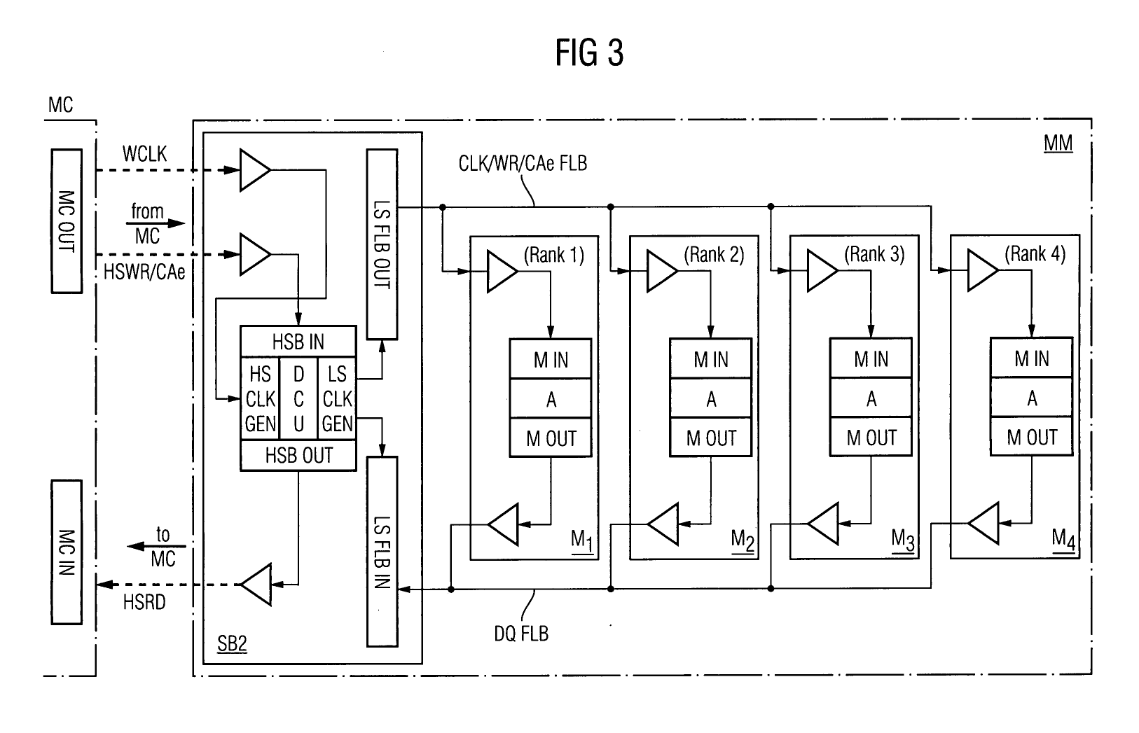

One embodiment of the present semiconductor memory system illustrated in FIG. 3 differs from the first preferred embodiment in that the memory chips M1 to M4 are arranged on the memory module MM and respectively connected in a fly-by fashion by the low speed clock/write data/command and address signal lines from a smart buffer chip SB2 for transferring low speed fly-by clock/write data/command and address signals CLK/WR/CAeFLB and by the low speed read data lines to the smart buffer chip SB2 for transferring low speed fly-by data query signals DQ FLB. Therefore the smart buffer chip SB2 differs from the smart buffer chip SB1 of the first preferred embodiment in the construction and function of its low speed output and interface section LSFLBOUT and LSFLBIN on the basis of the low speed fly-by bus connection.

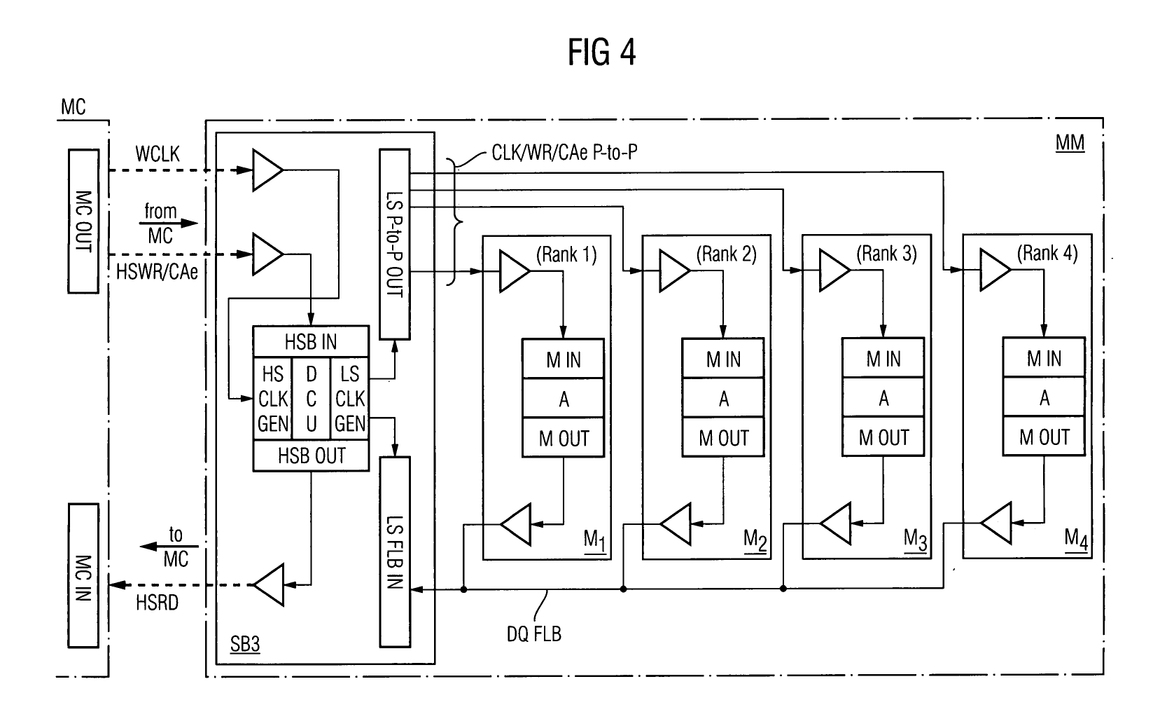

One embodiment of the present semiconductor memory system depicted in FIG. 4 differs from the embodiments as depicted in FIGS. 2 and 3, respectively in that the semiconductor memory chips M1 to M4 are arranged on the memory module MM and connected to the smart buffer chip SB3 by low speed write data lines CLK/WR/CAe P-to-P in a point-to-point fashion and by low speed read data lines DQFLB in a fly-by bus fashion, and that said low speed output interface section LS P-to-P OUT of the smart buffer chip SB3 is adapted to carry out the point-to-point transmission of the CLK/WR/CAe P-to-P signals and that the low speed input interface section LSFLBIN of the smart buffer chip SB3 is adapted to carry out the receipt of the low speed data query (read) signals DQFLB from the memory chips M1 to M4 in the fly-by fashion. All other components and functions of the semiconductor memory chips M1 to M4 and the smart buffer chip SB3 on the memory module MM4 as well as the components and functions of the memory controller MC are respectively equal to the functions and components of the embodiments according to the FIGS. 2 and 3.

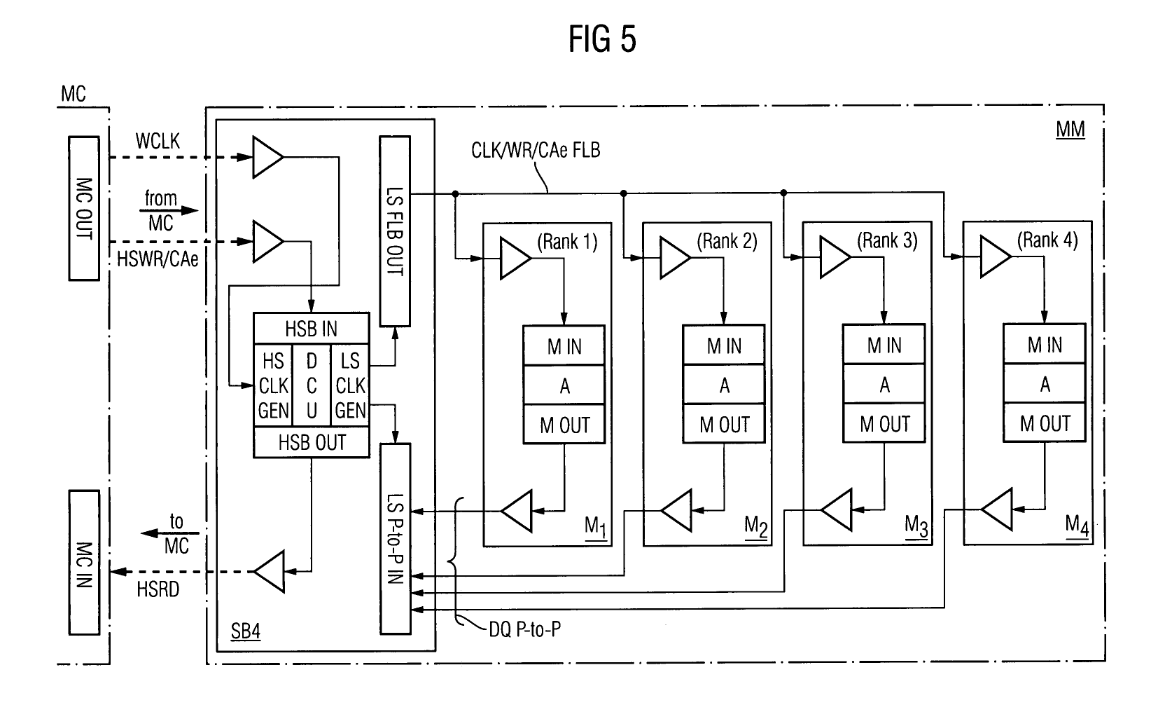

Finally, one embodiment of the present semiconductor memory system illustrated in FIG. 5 includes like the system of FIG. 4 a mixed bus connection between the smart buffer chip SB4 and the memory chips M1 to M4 on the memory module MM. The present embodiment differs from the embodiment of the semiconductor memory system according to FIG. 4 in that the low speed CLK/WR/CAeFLB signal transmission is carried out through a fly-by bus connection and the low speed data query (read data) DQ P-to-P transmission from the memory chips M1 to M4 to the smart buffer chip SB4 is carried out in a point-to-point fashion. The low speed output interface section LSFLBOUT of the smart buffer chip is adapted to carry out the transmission of CLK/WR/CAeFLB in the fly-by fashion and the low speed input interface section LS P-to-P IN thereof is adapted to carry out the receipt of the data query (read data) signals DQ P-to-P in the point-to-point fashion.

All other components and functions of the embodiment of the present semiconductor memory system depicted in FIG. 5 are equal to the respective components and functions of the embodiments of the present semiconductor memory system as illustrated in FIGS. 2 to 4.

The following describes with reference to FIG. 6 a general outline of components and functions of a smart buffer chip SB corresponding to SB1 to SB4 illustrated in FIGS. 2 to 5. As described above and illustrated in FIGS. 2 to 5, the smart buffer chips SB1 to SB4 generally include the high speed buffer interface circuits HSBIN and HSBOUT forming together with the high speed clock generator HSCLKGEN a high speed interface HSINT, further the low speed output interface section LSOUT (FLB or P-to-P), the low speed input interface section LSIN (FLB or P-to-P) forming together with the low speed clock generator LSCLKGEN a low speed interface LSINT(prop), and the digital control unit DCU being interposed between the high speed interface HSINT and the low speed interface LSINT. The low speed output interface LSOUT (FLB or P-to-P) of SB1 to SB4 is divided in a low speed command and address signal output interface LSCAeOUT and a low speed write data output interface LSWROUT.

The following description discusses components and functions of the high speed interface HSINT, low speed interface LSINT and the digital control unit DCU in this order with reference to FIG. 6.

I. High Speed Interface HSINT

a) High Speed Buffer Output Interface HSBOUT

The high speed buffer output interface HSBOUT includes a number N of transmission signal serializing and synchronizing output buffer circuits which are clocked and synchronized by the high speed transmission clock signal TXCLK(HS) generated by and supplied from the high speed clock generator HSCLKGEN. All output buffer circuits in one case have identical circuit construction. The number N of the output buffer circuits within HSBOUT equals to the bus width N of the serial high speed read data bus transmitting the serial high speed read data signals HSRD from the smart buffer chip SB to the high speed serial input interface MCIN of the memory controller MC. Each of the N output buffer circuits of HSBOUT includes a read FIFO circuit RFIFO adapted for buffering parallel read data signals received in signal frames from the digital control unit DCU, a parallel-to-serial converter P/S adapted for parallel-to-serial converting the parallel read data signals from RFIFO into a high speed serial read data stream, a synchronizing and de-emphasizing circuit DE for synchronizing and de-emphasizing the high speed serial read data stream by said high speed transmission clock signal TXCLK(HS) and a driver circuit for driving the synchronized and de-emphasized serial high-speed read data stream HSRD to the memory controller MC.

b) High Speed Buffer Input Interface HSBIN

HSBIN is adapted for receiving serial high speed write data, command and address signal streams HSWR/CAe from MC and includes a number O of reception signal parallelizing and synchronizing input buffer circuits clocked and synchronized by the high speed reception clock signal RXCLK(HS) generated by and supplied from the high speed clock generator HSCLKGEN. Each of the O reception signal parallelizing and synchronizing input buffer circuits has in one case an identical circuit construction and includes a receiver circuit adapted for receiving the serial stream of high speed write data, command and address signals HSWR/CAe through the serial high speed write data/command and address signal lane, a synchronizing circuit SYNC adapted for synchronizing the serial high speed write data, command and address signal stream by the high speed reception clock signal RXCLK(HS), a serial-to-parallel converting circuit S/P adapted for serial-to-parallel converting the serial stream of high speed write data, command and address signals HSWR/CAe synchronized by SYNC to parallel high speed write data, command and address signals, and a write FIFO WFIFO buffering the parallel high speed write data, command and address signals for handing it over to the digital control unit DCU.

c) High Speed Clock Generator HSCLKGEN

The high speed clock generator HSCLKGEN receives the high speed write clock signal WCLK from the memory controller MC and includes a phase-locked loop PLL-based or a delay-locked loop DLL-based high speed clock generation circuit which generates in a phase-locked relation or a delay-locked relation the high speed write clock signal WCLK from the memory controller MC the high speed transmission clock signal TXCLK(HS) and the high speed reception clock signal RXCLK(HS) respectively. TXCLK(HS) is distributed to the N output buffer circuits of HSBOUT by means of a high speed transmission clock signal distribution tree, while RXCLK(HS) is distributed to the O input buffer circuits of HSBIN by means of a high speed reception clock signal distribution tree.

Further, the high speed clock generator HSCLKGEN includes a clock divider/buffer circuit CLKDIV/BUF which divides a frequency of the high speed write clock signal WCLK by a predetermined number and buffers the divided clock signal to supply it as a base clock signal BCLK to the digital control unit DCU and the low speed interface LSINT. FIG. 6 further illustrates that the high speed clock generator HSCLKGEN generates and transmits a high speed read clock signal RCLK to MC.

II. Low Speed Interface LSINT

a) Low Speed Write Data Output Interface LSWROUT

The low speed write data output interface LSWROUT includes a number R of low speed write signal transmitting units, which in one case have identical circuit construction. In case of the embodiments according to FIGS. 2 and 4 the number R equals to the product of the number of the memory chips on the memory module at a bit width of the low speed write data lines (point-to-point connection), and in case of the embodiments according to FIGS. 3 and 5 the number R is equal to the bit width of the low speed write data lanes (fly-by connection). Each of said R low speed write signal transmitting units of the low speed write data output interface LSWROUT includes a write FIFO WFIFO adapted for buffering frame decoded parallel low speed data signals from the digital control unit DCU, a synchronizing circuit SYNC adapted for synchronizing the buffered parallel low speed write data signals with a low speed transmission clock signal TXCLK generated by and supplied from the low speed clock generator LSCLKGEN and a driver circuit for driving the synchronized low speed write data signals LSWR to one or more of the memory chips M1 to M4.

b) Low Speed Command and Address Signal Output Interface LSCAeOUT

LSCAeOUT includes Q command and address signal transmitting units, which in one case have the same circuit construction as the low speed write signal transmitting units of the low speed write data output interface LSWROUT, wherein the number Q in the embodiments according to the FIGS. 2 and 4 is equal to the product of the number of the memory chips M1 to M4 on the memory module MM and a bit width of the low speed command and address signal lines (point-to-point connection), and in case of the embodiments illustrated in FIGS. 2 and 5 the number Q is equal to the number of the low speed command and address signal lines.

c) Low Speed Input Interface LSIN

The low speed input interface LSIN includes a number P of low speed read signal receiving units including a receiver circuit for receiving the read data signals (or data query signals) LSDQ, a synchronizing circuit SYNC synchronizing the received low speed read data signal with a low speed reception clock signal RXCLK(LS) generated by and supplied from the low speed clock generator LSCLKGEN and a read FIFO RFIFO buffering the synchronized low speed read data signals for handing it over to the digital control unit DCU. The number P of the low speed read signal receiving units of the low speed interface LSIN in the case of the embodiments according to FIGS. 2 and 5 is equal to the product of the number of the memory chips M1-M4 on the memory module MM and a bit width of the low speed data line (point-to-point connection), and in case of the embodiments according to FIGS. 3 and 4 the number P is equal to the bit width of the low speed read data lines.

d) Low Speed Clock Generator LSCLKGEN

The low speed clock generator LSCKLGEN includes a phase-locked loop based or a delay-locked loop based low speed clock generation circuit PLL or DLL receiving the low speed base clock signal BCLK from the digital control unit DCU as generated by the clock divider/buffer circuit CLKDIV/BUF of the high speed clock generator HSCLK and is adapted for generating in a phase-locked relation or in a delay-locked relation to the base clock signal BCLK the low speed transmission clock signal TXCLK(LS) which is distributed by a clock distribution tree to each of the low speed write signal transmitting units and the command and address signal transmitting units of the low speed write data output interface LSWROUT and the low speed command and address signal output interface LSCAeOUT. The phase-locked loop based or the delay-locked loop based low speed clock generation circuit further generates the low speed reception clock signal RXCLK(LS) on the basis of the base clock signal BCLK. The low speed reception clock signal RXCLK(LS) is distributed by a clock distribution tree to each of the P low speed read signal receiving units of the low speed input interface LSIN.

III. Digital Control Unit DCU

The digital control unit DCU forms the digital control part of a genuine high speed serial link and includes the complete digital functions concerning the protocol layer, error coding, frame coding and decoding, command and address decoding, posted read buffer and posted write buffer. DCU functionally can be divided in a read signal processing section RDP and a write, command and address signal processing section WRCAeP.

a) Read Signal Processing Section RDP

The read signal processing section RDP includes a memory read control unit MRDCU connected to an output side of the read FIFO RFIFO of each of the low speed read signal receiving units of the low speed input interface LSIN, a de-skew unit DESK having a de-skewing function for the read signal, a posted read buffer PRB, a CRC-coding and re-ordering unit CRCCOD and a framing unit F, the output of which is connected to the read FIFO circuit RFIFO of the high speed buffer output interface HSBOOUT. The processings of the read signal processing section RDP are controlled by the read finite state machine RFSM.

b) Write, Command and Address Signal Processing Section WRCAeP

WRCAeP is designed for processing the data signals and the command and address signals handed over by WFIFO of the high speed buffer input interface HSBIN.

The write, command and address signal processing section WRCAeP includes a de-skewing and CRC-coding unit DESK/CRCCOD connected to an output side of each write FIFO circuit WFIFO of HSBIN, a frame decoding unit FDEC, a command and address signal decoding unit CAeDEC, a posted write buffer unit PWB and a memory write control unit MWRCU arranged for receiving decoded command and address signals from the command and address decoding unit CAeDEC, frame decoded write data signals from the frame decoding unit FDEC and CRC bits from the de-skew and CRC coding unit DESK/CRCCOD as well as buffered posted write signals from the posted write buffer unit PWB and for handing over the processed low speed write data signals and the processed low speed command and address signals to the write FIFO circuit WFIFO of the low speed write signal transmitting units and the low speed command and address signal transmitting units of the low speed write data output interface LSWROUT and the low speed command and address signal output interface LSCAeOUT, respectively.

In one case, the digital control unit DCU further includes a low speed digital control unit interface LSDCUINT primarily for receiving DCU setup signals DCUSETUP as well as transmitting signals characterizing the states of the DCU. It is further to be mentioned that the low speed buffer interface LSINT forms a proprietary low speed buffer interface in which certain decoding functions have not to be carried out.

Alternatively the DCU of the present semiconductor memory system may includes instead of the proprietary low speed buffer interface LSINT a standard DDR2 or DDR3 interface which includes functional units to carry out all decoding functions.

It is to be understood that the terms “low speed” and “high speed” of functions and components of the present memory system respectively refer to low and high operational frequencies and transmission speeds, wherein the frequency of the low speed is essentially lower than the frequency of the high speed.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

What is claimed is:

1. A semiconductor memory system, comprising:
a memory controller arranged for transmitting serial high speed write data, command and address signal streams as signal frames based on a predefined transmission protocol through a point-to-point write data, command and address signal bus having a predetermined write bus width, and a high speed write clock signal and for receiving serial high speed read data signal streams as signal frames on the basis of said transmission protocol through a point-to-point-read data bus having a predetermined read bus width; and
a memory module being connected to said memory controller by means of said point-to-point-read data bus, said point-to-point write data, command and address signal bus and a write clock signal line and comprising:
a smart buffer chip; and
a plurality of semiconductor memory chips connected to low speed write data lines, low speed command and address signal lines, low speed memory clock signal lines and low speed read data signal lines, said semiconductor memory chips and said low speed signal lines being arranged on said memory module according to a certain topology for receiving low speed write data signals, command and address signals and a low speed memory clock signal from said smart buffer chip and for transmitting low speed read data signals to said smart buffer chip;
said smart buffer chip being interposed as a high speed serial link between said memory chips and said memory controller and comprising:
a high speed interface section being connected to said memory controller by means of said point-to-point read data bus, said point-to-point write data, command and address signal bus and said write clock signal line for receiving from said memory controller said serial high speed write data, command and address signal streams and said write clock signal and transmitting said serial high speed read data signal streams to said memory controller;
a low speed interface section connected to said memory chips through said low speed write data lines, said low speed command and address signal lines, memory clock signal lines and low speed read data signal lines for transmitting to said memory chips said low speed write data, said command and address signals and said memory clock signal and for receiving said low speed read data signals from said memory modules; and
a digital control unit being interposed between the high speed and the low speed interface sections and configured for buffering, speed converting and rearranging the signals flowing between the high speed and low speed interface sections, signal framing and frame decoding according to the protocol, code redundancy coding, decoding and error checking and command and address signal decoding;
a high speed clock generator; and
a low speed clock generator,
said high speed clock generator being adapted for generating high speed transmission and reception clock signals derived from the high speed write clock signal, and said low speed clock generator being adapted for generating low speed transmission and reception clock signals and said low speed memory clock signal each on the basis of a low speed base clock signal obtained by frequency dividing said high speed write clock signal from said memory controller.

2. The semiconductor memory system of claim 1, wherein said memory chips are arranged on said memory module and connected with the smart buffer chip by said low speed write data lines, low speed command and address signal lines and by said low speed read data lines in a point-to-point fashion, and said low speed interface section of the smart buffer chip includes a first number of low speed write signal transmitting units, a second number of low speed command and address signal transmitting units and a third number of low speed read signal receiving units, wherein said first, second and third number are respectively corresponding to the product of a number of the memory chips on the memory module and a bit width of the low speed write data lines, command and address signal lines and low speed read data lines.

3. The semiconductor memory system of claim 1, wherein said memory chips are arranged on said memory module and connected with the smart buffer chip by said low speed write data lines, said low speed command and address signal lines and said low speed read data lines in a fly-by-bus fashion, and said low speed interface section of the smart buffer chip includes a first number of low speed write signal transmitting units, a second number of low speed command and address signal transmitting units, and a third number of low speed read signal receiving units, wherein said first, second and third number are respectively corresponding to the respective bit width of the low speed write data lines, low speed command and address signal lines and low speed read data lines.

4. The semiconductor memory system of claim 1, wherein said memory chips are arranged on said memory module and connected with the smart buffer chip by said low speed write data lines and said low speed command and address signal lines in a point-to-point-fashion and by said low speed read data lines in a fly-by-bus fashion, and said low speed interface section of the smart buffer chip comprising:
a first number of low speed write signal transmitting units and a second number of low speed command and address signal transmitting units, wherein said first and second number are respectively corresponding to the product of a number of the memory chips on the memory module and a bit width of the low speed write data lines and a bit width of the command and address signal lines, respectively; and
a third number of low speed read signal receiving units which is corresponding to a bit width of said low speed read data lines.

5. The semiconductor memory system of claim 1, wherein said memory chips are arranged on said memory module and connected with said smart buffer chip by said low speed write data lines and said low speed command and address signal lines from said smart buffer chip in a fly-by-bus fashion and by said low speed read data lines to said smart buffer chip in a point-to-point-fashion and said low speed interface section of the smart buffer chip comprises:
a first number of low speed write signal transmitting units;
a second number of low speed command and address signal transmitting units, wherein said first and second number are respectively corresponding to a bit width of said low speed write data lines and low speed command and address signal lines, respectively; and
a third number of identical low speed read signal receiving units which is corresponding to the product of a number of the plurality of memory chips on the memory module and a bit width of said low speed read data lines.

6. The semiconductor memory system of claim 1, wherein said high speed interface section comprises:
a first number of transmission signal serializing and synchronizing output buffer circuits clocked and synchronized by said high speed transmitter clock signal from said high speed clock generator, each output buffer circuit having means for:
buffering parallel read data signals received in form of signal frames from said digital control unit;
parallel-to-serial converting said parallel read data signals into a high speed serial read data stream;
synchronizing and de-emphasizing said high speed serial read data streams by said high speed transmission clock signal; and
driving said synchronized and de-emphasized serial high speed read data stream to said memory controller, wherein said first number corresponds to the read bus width;
a second number of reception signal parallelizing and synchronizing input buffer circuits, clocked and synchronized by said high speed receiver clock signal from said high speed clock generator, each input buffer circuit having means for:
receiving said serial high speed write data, command and address signal frames from said memory controller;
synchronizing said serial high speed write data, command and address signal streams by said high speed reception clock signal;
serial-to-parallel converting said serial high speed high data, command and address signal streams to parallel high speed write data, command and address signals; and
buffering said parallel high speed write data, command and address signals for handing it over to said digital control unit, wherein said second number corresponding to the write bus width.

7. The semiconductor memory system of claim 1, wherein said low speed interface section comprises:
a plurality of low speed write signal transmitting units;
a plurality of low speed command and address signal transmitting units; and
a plurality of low speed read signal receiving units;
wherein each of said low speed write signal transmitting units and said command and address signal transmitting units includes means for:
buffering frame decoded parallel low speed write data signals from said digital control unit;
synchronizing the buffered parallel low speed write data signals with the low speed transmission clock signal; and
driving said synchronized low speed write data signals to one or more of said memory chips through said low speed write data lines; and
wherein each of said low speed read signal receiving units includes means for:
receiving said low speed read data signals in parallel from one or more of said memory chips through said low speed read data signal lines;
synchronizing said received low speed read data signals with said low speed reception clock signal; and
buffering said synchronized low speed read data signals for handing over them to said digital control unit.

8. The semiconductor memory system of claim 6, wherein said high speed clock generator comprises:
a phase-locked loop based high speed clock generation circuit arranged for receiving said high speed write clock signal from said memory controller and generating in a phase-locked relation or in a delay-locked relation thereto said high speed transmission clock signal and said high speed reception clock signal, respectively; and
a clock divider/buffer circuit adapted for dividing the clock frequency of the high speed write clock signal by a predetermined number and buffering the divided clock signal as the base clock signal to supply it to the digital control unit.

9. The semiconductor memory system of claim 1, wherein said low speed clock generator comprising:
a phase-locked loop based low speed clock generation circuit arranged for receiving said low speed base clock signal from the clock divider/buffer circuit in said high speed clock generator and generating in a phase-locked relation or a delay locked relation thereto said low speed transmission clock signal, said low speed reception clock signal and said low speed memory clock signal.

10. The semiconductor memory system of claim 6, wherein said digital control unit comprises:
a read signal processing section including in the sequence of read signal flow:
a memory read control unit connected to an output side of the buffering means of each of said low speed read signal receiving units;
a de-skew unit;
a posted read buffer;
a CRC coding and reordering unit; and
a framing unit, the output of which is connected to the buffering means of the high speed interface section;
wherein the processing of said units of said read signal processing section being controlled by a read finite state machine of said digital control unit; and
a write, command and address signal processing section including in the sequence of write, command and address signal flow:
a de-skew and CRC coding unit connected to an output side of said buffering means of said reception signal parallelizing and synchronizing input buffer circuits;
a frame decoding unit;
a command and address decoding unit;
a posted write buffer unit; and
a memory write control unit arranged for receiving:
decoded command and address signals from the command and address decoding unit;
frame decoded write data signals from the frame decoding unit;
CRC bits from the de-skew and CRC coding unit; and
buffered posted write signals from the posted write buffer unit and handing over the processed low speed write data signals and the processed low speed command and address signals to the buffering means of said low speed write signal transmitting units and said low speed command and address signal transmitting units, respectively;
wherein the processing of said units of said write, command and address signal processing section is controlled by a write finite state machine of said digital control unit.

11. A semiconductor memory comprising:
a memory controller arranged for transmitting serial high speed write data, command and address signal streams as signal frames based on a predefined transmission protocol through a point-to-point write data, command and address signal bus having a predetermined write bus width, and a high speed write clock signal and for receiving serial high speed read data signal streams as signal frames on the basis of said transmission protocol through a point-to-point-read data bus having a predetermined read bus width; and
a memory module being connected to said memory controller by means of said point-to-point-read data bus, said point-to-point write data, command and address signal bus and a write clock signal line and comprising:
a plurality of semiconductor memory chips connected to low speed write data lines, low speed command and address signal lines, low speed memory clock signal lines and low speed read data signal lines, said semiconductor memory chips and said low speed signal lines being arranged on said memory module according to a certain topology for receiving low speed write data signals, command and address signals and a low speed memory clock signal from said smart buffer chip and for transmitting low speed read data signals to said smart buffer chip; and
a smart buffer chip interposed as a high speed serial link between said memory chips and said memory controller and comprising:
a high speed interface section being connected to said memory controller by means of said point-to-point read data bus, said point-to-point write data, command and address signal bus and said write clock signal line for receiving from said memory controller said serial high speed write data, command and address signal streams and said write clock signal and transmitting said serial high speed read data signal streams to said memory controller;
a low speed interface section connected to said memory chips through said low speed write data lines, said low speed command and address signal lines, memory clock signal lines and low speed read data signal lines for transmitting to said memory chips said low speed write data, said command and address signals and said memory clock signal and for receiving said low speed read data signals from said memory modules; and
control means between the high and low speed interface sections for buffering, speed converting and rearranging the signals flowing between the high speed and low speed interface sections, signal framing and frame decoding according to the protocol, code redundancy coding, decoding and error checking and command and address signal decoding;
high speed clock means for generating high speed transmission and reception clock signals derived from the high speed write clock signal; and
low speed clock means for generating low speed transmission and reception clock signals.

12. The semiconductor memory system of claim 11, wherein said memory chips are arranged on said memory module and connected with the smart buffer chip by said low speed write data lines, low speed command and address signal lines and by said low speed read data lines in a point-to-point fashion, and said low speed interface section of the smart buffer chip includes a first number of low speed write signal transmitting units, a second number of low speed command and address signal transmitting units and a third number of low speed read signal receiving units, wherein said first, second and third number are respectively corresponding to the product of a number of the memory chips on the memory module and a bit width of the low speed write data lines, command and address signal lines and low speed read data lines.

13. The semiconductor memory system of claim 11, wherein said memory chips are arranged on said memory module and connected with the smart buffer chip by said low speed write data lines, said low speed command and address signal lines and said low speed read data lines in a fly-by-bus fashion, and said low speed interface section of the smart buffer chip includes a first number of low speed write signal transmitting units, a second number of low speed command and address signal transmitting units, and a third number of low speed read signal receiving units, wherein said first, second and third number are respectively corresponding to the respective bit width of the low speed write data lines, low speed command and address signal lines and low speed read data lines.

14. The semiconductor memory system of claim 11, wherein said memory chips are arranged on said memory module and connected with the smart buffer chip by said low speed write data lines and said low speed command and address signal lines in a point-to-point-fashion and by said low speed read data lines in a fly-by-bus fashion, and said low speed interface section of the smart buffer chip comprising:
a first number of low speed write signal transmitting units and a second number of low speed command and address signal transmitting units, wherein said first and second number are respectively corresponding to the product of a number of the memory chips on the memory module and a bit width of the low speed write data lines and a bit width of the command and address signal lines, respectively; and
a third number of low speed read signal receiving units which is corresponding to a bit width of said low speed read data lines.

15. The semiconductor memory system of claim 11, wherein said memory chips are arranged on said memory module and connected with said smart buffer chip by said low speed write data lines and said low speed command and address signal lines from said smart buffer chip in a fly-by-bus fashion and by said low speed read data lines to said smart buffer chip in a point-to-point-fashion and said low speed interface section of the smart buffer chip comprises:
a first number of low speed write signal transmitting units;
a second number of low speed command and address signal transmitting units, wherein said first and second number are respectively corresponding to a bit width of said low speed write data lines and low speed command and address signal lines, respectively; and
a third number of identical low speed read signal receiving units which is corresponding to the product of a number of the plurality of memory chips on the memory module and a bit width of said low speed read data lines.

16. The semiconductor memory system of claim 11, wherein said high speed interface section comprises:
a first number of transmission signal serializing and synchronizing output buffer circuits clocked and synchronized by said high speed transmitter clock signal from said high speed clock generator, each output buffer circuit having means for:
buffering parallel read data signals received in form of signal frames from said digital control unit;
parallel-to-serial converting said parallel read data signals into a high speed serial read data stream;
synchronizing and de-emphasizing said high speed serial read data streams by said high speed transmission clock signal; and
driving said synchronized and de-emphasized serial high speed read data stream to said memory controller, wherein said first number corresponds to the read bus width;
a second number of reception signal parallelizing and synchronizing input buffer circuits, clocked and synchronized by said high speed receiver clock signal from said high speed clock generator, each input buffer circuit having means for:
receiving said serial high speed write data, command and address signal frames from said memory controller;
synchronizing said serial high speed write data, command and address signal streams by said high speed reception clock signal,
serial-to-parallel converting said serial high speed high data, command and address signal streams to parallel high speed write data, command and address signals; and
buffering said parallel high speed write data, command and address signals for handing it over to said digital control unit, wherein said second number corresponding to the write bus width.

17. The semiconductor memory system of claim 11, wherein said low speed interface section comprises:
a plurality of low speed write signal transmitting units;
a plurality of low speed command and address signal transmitting units; and
a plurality of low speed read signal receiving units;
wherein each of said low speed write signal transmitting units and said command and address signal transmitting units includes means for:
buffering frame decoded parallel low speed write data signals from said digital control unit;
synchronizing the buffered parallel low speed write data signals with the low speed transmission clock signal; and
driving said synchronized low speed write data signals to one or more of said memory chips through said low speed write data lines; and
wherein each of said low speed read signal receiving units includes means for:
receiving said low speed read data signals in parallel from one or more of said memory chips through said low speed read data signal lines;
synchronizing said received low speed read data signals with said low speed reception clock signal; and
buffering said synchronized low speed read data signals for handing over them to said digital control unit.

18. The semiconductor memory system of claim 16, wherein said high speed clock generator comprises:
a phase-locked loop based high speed clock generation circuit arranged for receiving said high speed write clock signal from said memory controller and generating in a phase-locked relation or in a delay-locked relation thereto said high speed transmission clock signal and said high speed reception clock signal, respectively; and
a clock divider/buffer circuit adapted for dividing the clock frequency of the high speed write clock signal by a predetermined number and buffering the divided clock signal as the base clock signal to supply it to the digital control unit.

19. The semiconductor memory system of claim 11, wherein said low speed clock generator comprising:
a phase-locked loop based low speed clock generation circuit arranged for receiving said low speed base clock signal from the clock divider/buffer circuit in said high speed clock generator and generating in a phase-locked relation or a delay locked relation thereto said low speed transmission clock signal, said low speed reception clock signal and said low speed memory clock signal.

20. The semiconductor memory system of claim 16, wherein said digital control unit comprises:
a read signal processing section including in the sequence of read signal flow:
a memory read control unit connected to an output side of the buffering means of each of said low speed read signal receiving units;
a de-skew unit;
a posted read buffer;
a CRC coding and reordering unit; and
a framing unit, the output of which is connected to the buffering means of the high speed interface section;
wherein the processing of said units of said read signal processing section being controlled by a read finite state machine of said digital control unit; and
a write, command and address signal processing section including in the sequence of write, command and address signal flow:
a de-skew and CRC coding unit connected to an output side of said buffering means of said reception signal parallelizing and synchronizing input buffer circuits;
a frame decoding unit;
a command and address decoding unit;
a posted write buffer unit; and
a memory write control unit arranged for receiving:
decoded command and address signals from the command and address decoding unit;
frame decoded write data signals from the frame decoding unit;
CRC bits from the de-skew and CRC coding unit; and
buffered posted write signals from the posted write buffer unit and handing over the processed low speed write data signals and the processed low speed command and address signals to the buffering means of said low speed write signal transmitting units and said low speed command and address signal transmitting units, respectively;
wherein the processing of said units of said write, command and address signal processing section is controlled by a write finite state machine of said digital control unit.
